(19) United States
(12) Patent Application Publication
(10) Pub. No.: US 2017/0189962 A1
(43) Pub. Date: Jul. 6, 2017

(54) PROCESS FOR PRODUCING A COMPONENT

(71) Applicant: PLANSEE SE, REUTTE (AT)

(72) Inventors: HEINRICH KESTLER, REUTTE (AT); GERHARD LEICHTFRIED, REUTTE (AT); MICHAEL O'SULLIVAN, EHENBICHL (AT); BERNHARD TABERNIG, PLACH (AT)

(21) Appl. No.: 15/324,877

(22) PCT Filed: Jun. 30, 2015
(86) PCT No.: PCT/AT2015/000093

§ 371 Date: Jan. 9, 2017

(30) Foreign Application Priority Data
Jul. 9, 2014 (AT) GM 277/2014

(51) Int. Cl. B22F 3/105; B22F 1/00; B22F 3/24; B22F 9/30; B33Y 70/00; B23K 15/00; B23K 26/00; B23K 26/342; B33Y 10/00; B22F 1/02; B22F 3/10

(52) U.S. Cl. CPC B22F 3/1055; B22F 1/025; B22F 1/0003; B22F 3/24; B22F 9/30; B22F 3/1035; B23K 15/0086; B23K 15/0093; B23K 26/0006; B23K 26/342; B33Y 10/00; B33Y 70/00; B22F 2003/248; B22F 2301/20; B22F 2301/15; B22F 2998/10; B23K 2203/08

(57) ABSTRACT

A method of producing a component from refractory metal or a refractory metal alloy having a refractory metal content >50 at %. The process includes the steps of providing a powder formed of particles and solidifying the powder under the action of a laser beam or electron beam. The powder has a particle size d₅₀ as measured laser-optically of >10 μm and an average surface area as measured by the BET method of >0.08 m²/g.

The invention relates to a process for producing a component from refractory metal or from a refractory metal alloy having a refractory metal content >50 at %, the process comprising the steps of providing a powder formed of particles and solidifying the powder under the action of a laser beam or electron beam.

Processes in which a component is built up on the basis of digital 3D construction data by layer wise application of a powder and solidification of the powder are referred to as additive manufacturing methods. Examples of terms used synonymously are generative manufacturing, 3D printing or digital photonic manufacturing. Additive manufacturing processes have advantages including the following:
high degree of freedom for component design;
no tools required; and
high resource efficiency.

In addition to the realization of components with functional design, there is also a great potential in the development of new materials, such as of materials with a functionally graduated construction, hybrid composite materials, materials with optimized microstructure or bionic materials, for example.

Starting from metallic powders, suitability for this purpose is possessed, for example, by selective laser sintering (SLS), selective laser melting (SLM), laser metal deposition (LMD), electron beam melting (EBM) or powder bed and also inkjet head 3D printing. In the case of selective laser sintering/melting, powder layers with a thickness typically in the range from 20 to 100 μm are applied. The laser powers nowadays are typically 200 to 1000 W; in the future, lasers with a higher power will also be available. The laser beam, then, scans the powder layer at a rate of up to 7 m/s, for example, under an atmosphere of inert gas-argon or nitrogen, for example. Under the action of the energy, the powder layer is solidified. Typically this is also accompanied by compaction. The focal diameter of the laser beam is typically in the range from 20 to 200 μm, in certain cases up to 1000 μm. The build rate is typically in the range from 5 to 15 cm³/h. The process enables components having a surface quality Rz typically in the range from 20 to 100 μm and an accuracy typically in the range from 50 to 100 μm. In order to increase the build rate, it is possible to build up the edge zone region with a small focal diameter, in the region of 200 μm, for example, in order to achieve good surface quality and accuracy. In the core region, the powder layer is solidified/compacted with a larger focal diameter, of 1000 μm, for example, in order to obtain a high build rate.

In the case of LMD, the powder is not applied layerwise, as with SLS/SLM, but is instead introduced directly in the region of the laser beam. The fused beads which this produces typically have a width of 0.3 to 3 mm.

In the case of electron beam melting, powder layers with thicknesses typically in the range from about 50 to 100 μm are applied. The typical powers of presently available electron beam melting units are 3 to 4 kW. Because of the charging events that occur on exposure of the powder layer to the electron beam, it is necessary, with electron beam melting, for electrically conducting connection to be produced in a first pass between the powder particles themselves and/or between the powder particles and the powder layer applied previously and already solidified, or else, in the case of the first powder layer, an electrically conducting connection between the powder particles and the base plate. This can be done, for example, by means of a defocused electron beam, which connects the powder particles to one another by way of a solid-phase sintering operation. Because of the possibility with electron beam melting of very high scan rates of up to 8000 m/s and also of relatively thick powder layers, the build rate is also much higher than in the case of selective laser sintering or melting. In the case of Ti6Al4V, for instance, the build rate is 55 to 80 cm³/h. The focal diameter of the electron beam can be varied typically in a range from 0.1 to 1 mm, and again with a small focal diameter it is possible to improve the accuracy and the roughness, situated typically at 130 to 200 μm and Rz>100 μm, respectively.

To enable broader application of powder-based additive manufacturing processes, the following technological challenges must still be solved in addition to the improvement in surface roughness and accuracy:
further increase in the build rate
reduction of the feasible wall thickness (presently limited at about 100 μm)
increase in operational constancy
broadening of the palette of materials
increase in component size (present limit 630×500×400 mm³)
reduction in internal stresses/warping.

These challenges/properties are influenced to a high degree by the solidification/compaction process. That process in turn collates to a high degree with the physical powder properties.

The solidification/compaction procedure may take place by solid-phase sintering, liquid-phase sintering or melting/solidifying. In the case of solid-phase sintering, the solidification/compaction takes place typically at a temperature in the range from 0.7× to just below the solidus temperature. The driving force in this case is the reduction in surface energy, while the most important transport mechanism is diffusion. Diffusion in turn may take place by the surface (surface diffusion), via grain boundaries (grain boundary diffusion) or via the particle volume (volume or lattice diffusion). In the region of the contact point between two particles, the inscribed radius is small, whereas in the region of the particle surface, the radius is comparatively large. Given that the vacancy density is dependent on the radius and increases as the radius falls, there is vacancy diffusion from the region of the contact area between two particles to the regions with a larger radius, or else, synonymously, there is atomic diffusion from the regions with a larger radius to the contact areas between the particles. In the region of the contact area, a so-called sinter neck is formed between the particles. In the case of liquid-phase sintering, liquid phase also occurs, at least temporarily, as well as solid phase.

In the case of solidification/compaction by way of melting processes, it is essential that the contraction accompanying solidification is uniform. It is advantageous, moreover, if the powder bed is uniformly heated, this in turn requiring a sufficiently high thermal conductivity in the powder layer. For compaction, furthermore, it is essential that the liquid phase formed effectively wets the solid particles that are still present. This is influenced on the one hand by the capillary forces, which are in turn dependent on the density of the powder bed, and on the other hand on surface-chemical effects. Other phenomena to be avoided are Marangoni convection and instances of balling or of evaporation.

At present, refractory metals are not yet being solidified/compacted via additive manufacturing processes on an industrial scale. Refractory metals in the context of this invention encompass the metals niobium, tantalum, chromium, molybdenum, tungsten and rhenium. One of the reasons why additive manufacturing processes have not yet become widely established for these materials is the limited availability of powders suitable for these manufacturing processes. With the powders used at present, the resulting materials properties and operational properties are of insufficient quality for a broad application of these manufacturing methods.

The powders are required in particular to have excellent filling properties, so that a uniform and sufficiently high density is ensured in every powder layer. Low density or non-uniform density of the powder layer results in uneven contraction and/or in the formation of relatively large pores or pore clusters. Solidification/compaction can only be achieved, via solid-phase sintering processes, with the given short energy exposure times, if the distances between particles are small and if the sintering activity is high. Sufficient solidification/compaction via solid-phase sintering is necessary, for example, when the powder is being compacted via an electron beam melting operation, since in that case, as already mentioned, in a first pass (preheating) the particles in the powder layer must be joined to one another to an extent such as to allow the charge carriers introduced by way of the electron beam to be diverted off in the second pass (melting operation) by way of the layers built up beforehand and/or by way of the base plate. If the particles are not joined to one another to a sufficiently high extent in the first pass, the result is charging effects and, subsequently, repulsion of the powder particles and destruction of the powder layer applied.

A uniform and high density of the applied powder layer is also advantageous in the context of selective laser sintering and melting. In the case of laser sintering, in particular, a high sintering activity in the solid phase has beneficial consequences. In the case of laser melting and of laser sintering with liquid phase, it is advantageous if the resulting melt has a low surface tension. If a sufficiently high solidification/compaction is achievable in solid phase, or if the requirements in terms of the density to be achieved are low, then SLS is preferred over SLM, since it allows better surface qualities and/or higher accuracies to be achieved in the components. Hence it is possible, for example, to reduce or completely eliminate downstream machining operations.

The object of the present invention, therefore, is to provide a process that allows the production of components from refractory metals with at least one of the following properties:
high surface quality
high accuracy
low wall thickness
high density, and low error density, such as pores/pore clusters
high static and dynamic strength
high ductility
fine-grained structure
low inherent stresses.

The process is also to permit a high build rate.

This object is achieved by the independent claim. Particular embodiments are shown in the sub-claims.

The inventive process allows the production of components from refractory metals or refractory metal alloys having a refractory metal content of >50 at %. As already mentioned, the term refractory metal encompasses the metals based on niobium, tantalum, chromium, molybdenum, tungsten and rhenium. The refractory metal content of the refractory metal alloys of the invention is >50 at %, preferably >70 or >80 at %. With more particular preference the refractory metal content is >90, >95 or 99 at %.

In accordance with the invention, then, a powder is used that is formed of particles and that has a particle size d₅₀ as measured laser-optically of >10 μm. This d₅₀ figure is measured by means of laser diffractometry. The results of the measurement are reported as a distribution curve. The d₅₀ indicates the average particle size. d₅₀ means that 50 vol % of the particles are smaller than the figure reported.

Furthermore, the powder has an average surface area as measured by the BET method of >0.08 m²/g. The BET measurement takes place according to a standard (ISO 9277:1995, measuring range: 0.01-300 m²/g; instrument: Gemini II 2370; heating temperature: 130° C.; heating time: 2 hours; adsorptive: nitrogen; volumetric evaluation via five-point determination). The BET surface area is preferably >0.1 or >0.13 m²/g. With particular preference the BET surface area is >0.15, >0.2 m²/g or >0.25 m²/g.

The powder is solidified and/or compacted under the action of a laser beam or electron beam. For this purpose the powder is preferably applied layerwise.

The process is distinguished by the following advantages:
Improved operating properties in electron beam melting:
In electron beam melting, in the first pass (preheating operation), sufficient formation of sinter necks via solid-phase sintering is obtained, for example, with a defocused electron beam. This prevents unwanted charging effects in the case of high energy density (second pass/melting operation).
High surface quality of the components thus produced:
The powder of the invention results in a high filling density (low inter-particle distances). Moreover, it has a very high sintering activity. This leads to a very uniform compaction/solidification process. If the requirements in terms of component density are not too high, complete melting can be omitted.
High accuracy:
Since the solidification/compaction operation can take place by means of solid-phase or liquid-phase sintering (sintering in the region of solid and liquid phase), narrower tolerances can be observed by comparison with solidification/compaction by melting/solidifying.
Low wall thickness:
Because the solidification/compaction operation can take place by solid-phase or liquid-phase sintering, it is possible to achieve lower wall thicknesses in comparison to solidification/compaction by melting/solidifying, since the penetration of the melt into adjacent regions of the powder layer, which are not intended for solidification, is prevented or reduced.
High density and low error density, such as pores/pore clusters:
The uniform filling characteristics and the high sintering activity reduce the number of large pores and pore clusters.
Low inherent stresses:
Since inherent stresses are induced by the solidification/cooling process, a reduction in the liquid-phase fraction has beneficial consequences.
Fine-grained structure:
Since the same density can be achieved with a relatively low energy input, it is possible to establish a more fine-grained structure.
High static and dynamic strength:
The aforementioned properties, such as the high density, the fine-grained structure and the low error density, for example, have beneficial consequences for both the static and the dynamic strengths.
High ductility:
The aforementioned properties also have beneficial consequences for the ductility.

Furthermore, the process of the invention also increases the build rate. This is true to a particularly high degree for electron beam melting, since unwanted charging phenomena are avoided completely in that case.

The particles advantageously have at least partly pores that are open towards the surface. This improves the formation of sinter necks between adjacent particles through surface diffusion. It is favourable, moreover, if the particles at least partly have spherical form. In combination with a porous surface, this also ensures that a uniform and high filling density of the powder layer is achieved.

It is advantageous, furthermore, if the coating material has a bimodal or multimodal particle distribution. A bimodal distribution is a frequency distribution having two maxima. A multimodal distribution has at least three maxima. A bimodal or multimodal distribution not only increases the degree of filling of the powder layer but also promotes solidification/compaction via solid-phase sintering events. A bimodal or multimodal particle size distribution has proved to be very favourable in the case of electron beam melting.

It is advantageous, furthermore, if the powder comprises particles in agglomerate and/or aggregate form that are formed of primary particles. The particles in this case may be present at least partly as aggregates, at least partly as agglomerates, or at least partly as a mixture of aggregates and agglomerates. An aggregate in powder metallurgy is understood as a cluster of primary particles which are joined to one another via strong bonding, whereas an agglomerate is a cluster of primary particles joined to one another via weak bonding (see, for example, German, R.: “Introduction to powder metallurgy science”, MPIF, Princeton (1984), 32). An aggregate in the context of this invention refers to a cluster which cannot be disrupted by customary ultrasound deagglomeration, whereas agglomerates can be broken down at least partly into the primary particles. The ultrasound deagglomeration here is carried out at 20 kHz and 600 W. The powder is advantageously in the form of an aggregate. The bonding between the primary particles of which the aggregate is made up is fusional (metallurgical bonding), preferably without assistance from other elements. With particular advantage >50, more particularly >70 and very advantageously >90% of all particles are in the form of aggregate or agglomerate. The evaluation in this case is made as follows: 5 samples are taken and are investigated using a scanning electron microscope. At a magnification which encompasses 20 to 50 particles in the sectional image, it is easy to determine the sum total of the particles present in the form of aggregate or agglomerate. After that, the number of particles present in the form of aggregate or agglomerate is referred to the total number of particles evaluated, and the average is determined from 5 samples. The agglomerate or aggregate form allows the combination of spherical form with a very high surface area, in turn promoting filling density and solid-phase sintering operations.

It has proved to be advantageous, furthermore, if the powder comprises 0.005 to 5 at % of at least one element from the group consisting of Ni, Co, Fe and Pd. As a result of these alloying elements, grain boundary diffusion events are triggered as well as surface diffusion, even in the case of very short energy exposure times, and this has proved to be beneficial both for particle contacting in the case of electron beam melting, and for the compaction process in the case of selective laser sintering. Since these elements reduce the surface tension of the liquid-melt phase, very smooth surfaces can be obtained both with SLM and with EBM.

In a further preferred embodiment, the powder is present at least partly as composite powder. Composite powders are understood more particularly to be powders consisting of two or more phase constituents, these phase constituents being preferably very small and homogeneously distributed. One preferred possibility for a composite powder is a powder which is present at least partly in coated form. The layer in this case can be made very thin (for example 50 nm to 5 μm). It has proved to be particularly favourable for the layer to comprise a metal, an alloy or a compound which has a lower melting point than the particle in the near-core region. The melting point difference (in K) is preferably 0.04 to 0.7× melting point (in K) of the near-centre region. Particularly preferred ranges are 0.04 to 0.5 and 0.04 to 0.3× melting point (in K). By this means it is possible not only for solid-phase sintering events to contribute to the solidifying/compacting process, but also for the compacting to take place via liquid-phase sintering. The liquid phase here is formed preferably from the coating of particles. The liquid phase may in turn favourably incipiently dissolve the rest of the particle in some regions. Advantageously, moreover, the material of the coating has a sufficiently low vapour pressure. With particular advantage the coating is made porous. By that means it is possible for solid-phase sintering events to be accelerated both through the reduction in the solidus temperature and through an increase in the surface area. It is advantageous, moreover, if the phase formed from the coating has a lower surface tension than would be the case if the particles were used uncoated.

A porous surface layer can be deposited in a simple manner by a fluidized bed process. In the fluidized bed (also called fluid bed) the as yet uncoated powder is agitated by a carrier medium (preferably a gas). At a particular flow rate, the powder bed becomes the fluidized bed. In the case of fluidized bed coating, then, a slurry, comprising the coating material preferably in a very fine form, as well as comprising a liquid and a binder for example, can be sprayed into the reaction chamber via a nozzle and can be deposited on the particles. Liquid and binder can be removed subsequently by customary processes, such as heat treatment, for example.

In a simple way, however, the powder that is essential to the invention can also be produced by granulating a precursor of the metal powder, an oxide for example, with subsequent reduction. Examples of particularly suitable granulating processes include spray granulation. The reducing step that follows the granulating is carried out preferably at a temperature >500° C., especially preferably >800° C.

As already mentioned, the powder that is essential to the invention is used preferably for compacting/solidifying by reaction of an electron beam. The powder for this purpose is applied layerwise and in a first step (preheating operation) is solidified/compacted via solid-phase sintering events, with a defocused electron beam, for example, to an extent such that sinter necks are formed at least partly and unwanted charging phenomena can be prevented in the downstream melting operation.

The powder that is essential to the invention is also outstandingly suitable, however, for compaction under the action of a laser beam, particularly if the solidifying/compacting takes place by solid-phase sintering or liquid-phase sintering.

The invention is described by way of example below.

### EXAMPLE 1

Fine-grained MoO₃ powder was introduced into a stirring tank and combined with a quantity of water so as to form a slurry. This slurry was processed to granules in a spray granulation unit. These granules were reduced to Mo metal powder in a two-stage process (reduction temperature 600 and 1050° C., respectively). The Mo metal powder produced in this way was screened at 90 μm. The powder particles were spherical in form and had pores open towards the surface. In accordance with the definition given in the description, the particles were in agglomerate/aggregate form. The d₅₀ as determined according to the description was 21 μm, the BET surface area 0.15 m²/g. The powder produced in this way was used for selective electron beam melting. The operation is given in the description. Preheating took place with a defocused electron beam under conditions which did not lead to melting. In the course of the subsequent scanning step with a focused electron beam, leading to the complete melting of the particles, there were no unwanted charging processes.

### EXAMPLE 2

Tungsten powder with spherical form, screened at 25 μm and 5 μm, was mixed with 0.1 mass % of fine-grained Ni powder. The d₅₀ and the BET of the mixture were >10 μm and >0.08 m²/g, respectively. With the powder mixture thus produced, sintering experiments were carried out with very short operating times (heating to 1200° C. in 3 minutes) in order to assess the solid-phase sinterability at low D×t levels (D . . . diffusion coefficient, t . . . time) and hence to make it possible to evaluate whether there is sufficient contacting between the particles during the preheating with defocused electron beam and/or during solidifying/compacting by means of laser beam (laser sintering). Comparatively, pure W powder with spherical form and the screen fraction 5 to 25 μm (BET surface area <0.08 m²/g) was heated to 1200° C. in 3 minutes. Whereas sinter neck formation was still not observable in the case of pure tungsten, the W—Ni mixture of the invention already showed sinter necks between the particles.

### EXAMPLE 3

WO₃ powder was introduced into a stirring tank and combined with a quantity of water so as to form a slurry. This slurry was processed to granules in a spray granulation unit. These granules were reduced to W metal powder in a one-stage operation (reducing temperature 1000° C.). The W metal powder thus produced was screened at 90 μm. The powder was spherical in form and had pores open towards the surface. According to the definition given in the description, the particles were in agglomerate/aggregate form. The d₅₀ as determined in accordance with the description was 17 μm, the BET surface area 0.18 m²/g. A layer of Ni approximately 1 μm thick was applied to the powder particles. In a procedure based on Example 2, the solid-phase sinterability at low D×t levels was determined by means of rapid heating. As a result of the coating it was possible to achieve formation of sinter necks even at 1000° C.

1-19. (canceled)

20. A method of producing a component from refractory metal or a refractory metal alloy having a refractory metal content >50 at %, the method comprising:
providing a powder formed of particles having a particle size d₅₀ as measured laser-optically of >10 μm and an average surface area as measured by the BET method of >0.08 m²/g; and
subjecting the powder to a laser beam or electron beam irradiation for solidifying the powder to form the component.

21. The method according to claim 20, wherein a surface of the particles at least partly has pores.

22. The method according to claim 20, wherein the particles at least partly have a spherical form.

23. The method according to claim 20, wherein the powder has a bimodal or multimodal particle size distribution.

24. The method according to claim 20, wherein the powder comprises powder particles in agglomerate form and/or aggregate form which are formed of primary particles.

25. The method according to claim 20, wherein the powder comprises 0.005 to 5 at % of at least one element selected from the group consisting of Ni, Co, Fe and Pd.

26. The method according to claim 20, wherein the powder is at least partly a composite powder.

27. The method according to claim 20, wherein the powder is at least partly a coated powder.

28. The method according to claim 20, wherein the particles at least partly have a lower melting point in near-surface regions than in near-center regions thereof.

29. The method according to claim 28, wherein a melting point difference, in Kelvin, between the melting points of the near-surface regions and the near-center regions is 0.04 to 0.7 times a melting point, in Kelvin, of the near-center regions.

30. The method according to claim 20, which comprises producing the powder with a granulating step.

31. The method according to claim 30, which comprises following the granulating step with a reducing step at a temperature >500° C.

32. The method according to claim 20, which comprises producing the powder with a coating step.

33. The method according to claim 20, wherein the powder comprises >80 at % of at least one element selected from the group consisting of Mo and W.

34. The method according to claim 20, wherein a BET surface area of the powder particles is >0.1 m²/g.

35. The method according to claim 34, wherein the BET surface area of the powder particles is >0.13 m2/g.

36. The method according to claim 20, which comprises applying the powder in layers.

37. The method according to claim 20, which comprises solidifying the powder with an electron beam, providing the powder layer-wise in layers, with the powder at least partly forming sinter necks in a first step through solid-phase sintering, and at least partly melting the powder in a subsequent step.

38. The method according to claim 37, which comprises performing the first step with a defocused electron beam.

39. The method according to claim 20, wherein the solidifying step comprises solid-phase sintering or liquid-phase sintering under action of a laser beam.
